(19) United States
(12) Patent Application Publication
(10) Pub. No.: US 2017/0155209 A1
(43) Pub. Date: Jun. 1, 2017

(54) STRUCTURE OF PREVENTING THE RELEASE OF NETWORK CABLE PLUG AND NETWORK CONNECTION BOX CONNECTING TO THE SAME

(71) Applicant: CABLE VISION ELECTRONICS CO., LTD, New Taipei City (TW)

(72) Inventors: Chien-Chung LEE, New Taipei City (TW); Chi-Tsung YANG, New Taipei City (TW)

(21) Appl. No.: 15/062,985

(22) Filed: Mar. 7, 2016

(30) Foreign Application Priority Data
Nov. 26, 2015 (TW) 104219030

(51) Int. Cl. H01R 13/627; H01R 13/621

(52) U.S. Cl. CPC H01R 13/6272; H01R 13/621

(57) ABSTRACT

A structure of preventing the release of a network cable plug includes a flexible clip and a positioning cover. The flexible clip includes a plate body, a pair of pins, and a hook plate. The pair of pins is connected against a side of the plug. The hook plate has a latch. The positioning cover includes a bottom cover and a top cover having a through groove. The plug is arranged on the bottom cover. The top cover covers part of the plug and part of the plate body through the plate body and the hook plate disposed through the through groove; the plug is plugged into the plug hole; the latch and the positioning portion are latched to each other. Therefore, the release of the plug can be prevented to ensure the plug to be plugged into the plug hole firmly.

### BACKGROUND OF THE INVENTION

### Field of the Invention

The present invention relates to a structure of a network cable, in particular, to a structure of preventing the release of a plug of a network cable and a network connection box connecting to the same.

### Description of Related Art

The traditional connection cable used in the computer connection, network establishment, or telephone line is equipped with a network cable plug, such as an RJ45 plug or RJ11 plug, at the plugging end thereof; the network cable plug is used for the plugging connection between the plugging end and the corresponding connecting port. However, during the plugging connection, there is still a gap between the plug and the connecting port. In this situation, when the network cable plug is disturbed by external force or vibration, the swaying movement of the plug or even drop-off may occur easily at the connecting point, which results in unstable connection.

The unstable connection will affect the data transmission. If the data transfer rate decreases, it will cause disconnection or damage the data. The unstable connection may cause severe damage to modern commercial activities which require heavy network communication. Thus, how to provide a structure of preventing the release of the network cable plug to ensure a firm connection of the communication plug into the connecting port becomes a research motivation of the inventor.

In view of this, the inventor pays special attention to research with the application of related theory and tries to improve and overcome the above disadvantages regarding the above related art, which becomes the improvement target of the inventor.

### SUMMARY OF THE INVENTION

It is an objective of the present invention to provide a structure of preventing the release of a network cable plug to ensure the plug can be plugged into a plug hole firmly.

In order to achieve the above objective, the present invention provides a structure of preventing the release of a network cable plug, which is combined with a plug of a network cable and connected to a plug hole with a positioning portion in a network connection box. The structure of preventing the release of a network cable plug comprises a flexible clip and a positioning cover. The flexible clip comprises a plate body, a pair of pins extending from the plate body, and a hook plate connected to a side of the plate body. The pair of pins is connected against a side of the plug and the hook plate has a latch. The positioning cover comprises a bottom cover and a top cover having a through groove. The plug is arranged on the bottom cover. The top cover covers part of the plug and part of the plate body through the plate body and the hook plate disposed through the through groove. The plug is plugged into the plug hole. The latch and the positioning portion are latched to each other.

It is another objective of the present invention to provide a structure of preventing the release of a network cable plug in which a fastener is provided to pass through a locking hole of the flexible clip to increase the pulling resistance between the plug and the plug hole such that the fastener presses against the plug and the fastener cannot be released easily from the locking hole.

Compared with the prior art, the structure of preventing the release of the network cable plug of the present invention uses the positioning cover to combine the flexible clip with the plug. Also, the flexible clip has a hook plate provided with a latch which is latched to the positioning portion of the plug hole. In this way, when the plug is disturbed by external force or vibration, the plug which is latched and positioned through the flexible clip will not release from the plug hole or shift; thus, the electrical connection between the plug and the plug hole can be ensured. Besides, the present invention is additionally provided with a fastener which passes through the locking hole of the flexible clip. Because the fastener presses against the plug, the fastener cannot be released easily from the plug hole, which enhances the pulling resistance between the plug and the plug hole and prevents the plug from being released from the plug hole. Therefore, security and convenience of use are improved.

### BRIEF DESCRIPTION OF DRAWING

FIG. 1 is a schematic view of the structure of preventing the release of a network cable plug of the present invention in operation;

FIG. 2 is a perspective exploded view of the structure of preventing the release of a network cable plug of the present invention;

FIG. 3 is a perspective view of the structure of preventing the release of a network cable plug of the present invention; and

FIG. 4 is a cross-sectional assembled view of the structure of preventing the release of a network cable plug of the present invention.

### DETAILED DESCRIPTION OF THE INVENTION

To further disclose the characteristics and technical details of the present invention, please refer to the following detailed description and accompanying figures. However, the accompanying figures are only for reference and explanation, but not to limit the scope of the present invention.

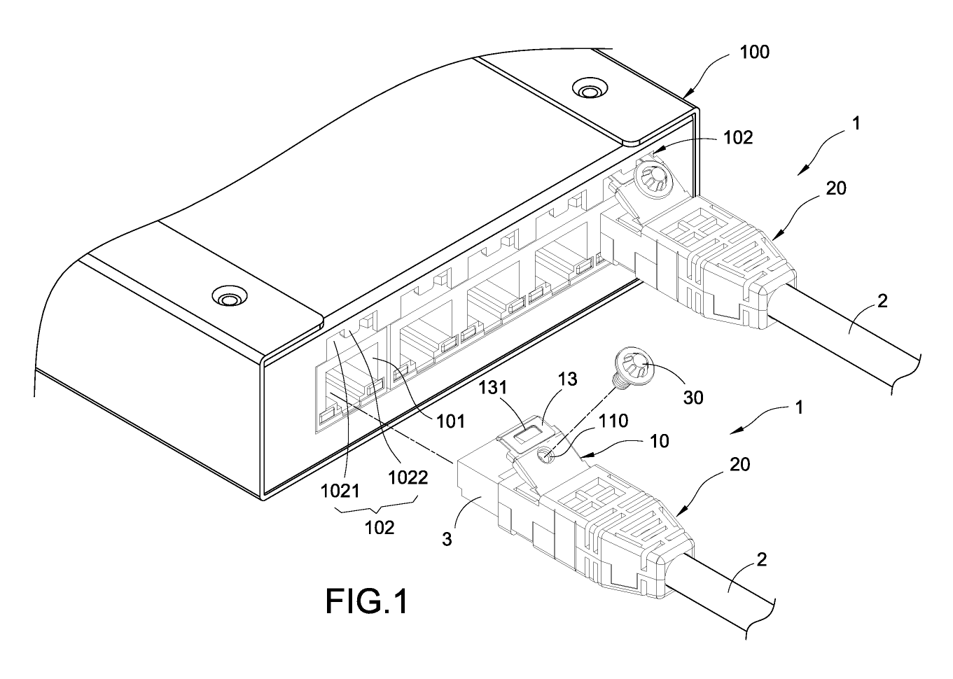

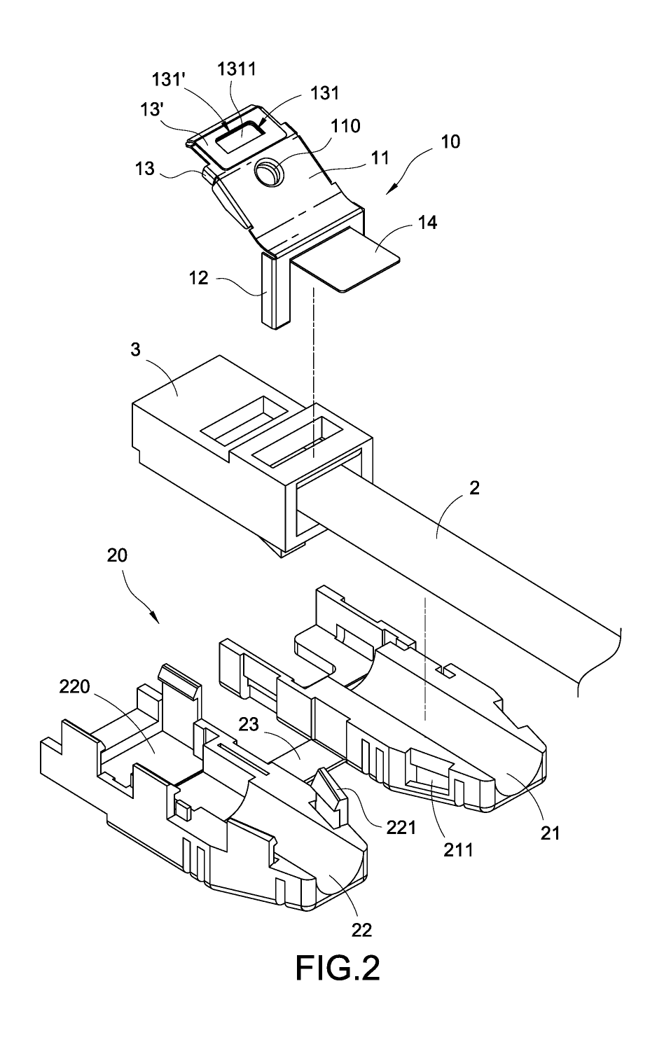

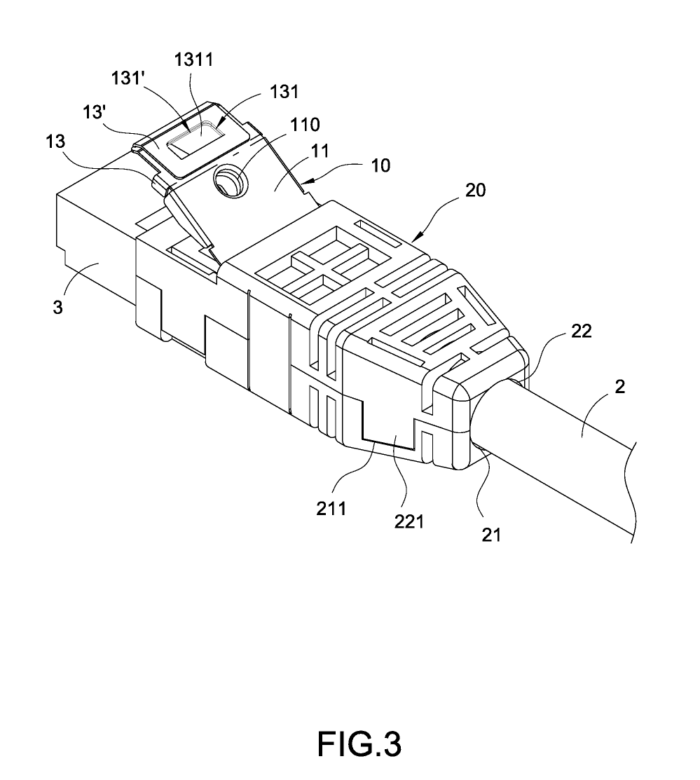

Please refer to FIGS. 1-3, which are the schematic view in operation, the perspective exploded view, and the perspective view of the structure of preventing the release of a network cable plug of the present invention, respectively. The structure of preventing the release of the network cable plug 1 of the present invention is combined with a plug 3 of a network cable 2 and connected to a network connection box 100 which has a plug hole 101 with a positioning portion 102. The structure of preventing the release of a network cable plug 1 comprises a flexible clip 10 and a positioning cover 20. The flexible clip 10 is combined with the plug 3 through the positioning cover 20.

The flexible clip 10 comprises a plate body 11, a pair of pins 12 extending from the plate body 11, and a hook plate 13 connected to a side of the plate body 11. The pair of pins 12 is connected against a side of the plug 3 and the hook plate 13 has a latch 131. Preferably, the flexible clip 10 is made of metal or plastic; the plate body 11, the pair of pins 12, and the hook plate 13 are integrally formed.

In the current embodiment, the hook plate 13 further comprises a reinforcement piece 13′ extending from the plate body 11. The reinforcement piece 13′ is reversely stacked on the hook plate 13 and another latch 131′ identical to the latch 131 is disposed on reinforcement piece 13′ corresponds to a position where the latch 131 is disposed.

The positioning cover 20 comprises a bottom cover 21 and a top cover 22 having a through groove 220. The plug 3 is arranged on the bottom cover 21. The top cover 22 covers the plug 3 and part of the plate body 11 through the plate body 11 of the flexible clip 10 and the hook plate 13 disposed through the through groove 220. Besides, the plug 3 is plugged into the plug hole 101 of the network connection box 100. The latch 131 of the flexible clip 10 and the positioning portion 102 of the network connection box 100 are latched to each other.

Preferably, the positioning cover 20 is made of metal or plastic; the bottom cover 21 and the top cover 22 can be integrally formed or separately disposed. In one embodiment of the present invention, a plurality of hook grooves 211 are spacedly disposed at the perimeter of the bottom cover 21 and a plurality of hooks 221 are spacedly disposed at the perimeter of the top cover 22. The bottom cover 21 and the top cover 22 are combined by means of mutual latching of the hook grooves 211 and the hooks 221. In addition, the positioning cover 20 further comprises a flexible piece 23 which is connected to the bottom cover 21 and the top cover 22 such that the bottom cover 21 and the top cover 22 can be combined together and will not get lost.

Moreover, the flexible clip 10 further comprises a supporting piece 14 connected to the other side of the plate body 11. The supporting piece 14 is disposed between the pair of the pins 12 and disposed a distance with the plate body 11. The supporting piece 14 and the part of the plate body 11 are latched by the top cover 22, which provides greater elastic force for the hook plate 13.

Preferably, the structure of preventing the release of a network cable plug 1 further comprises a fastener 30. Also, a locking hole 110 is disposed on the plate body 11 of the flexible clip 10 correspondingly. The fastener 30 passes through the locking hole 110 and presses against the plug 3.

The more detailed description of the network connection box 100 is given below. The network connection box 100 comprises a box body having at least one plug hole 101 and a positioning portion 102 disposed on a side of the plug hole 101. The plug 3 is plugged into the plug hole 101. The latch 131 and the positioning portion 102 are latched to each other.

In one embodiment of the present invention, the fastener 30 is an anti-theft screw and the locking hole 110 is a screw hole, but not limited to this case when the present invention is implemented.

During assembly, the pins 12 of the flexible clip 10 are firstly connected against a side of the plug 3 and placed in the bottom cover 21 of the positioning cover 20. Next, the top cover 22 is turn over and placed above on the bottom cover 21 to make the plate body 11 of the flexible clip 10 and the hook plate 13 pass through the through groove 220 such that the top cover 22 covers part of the supporting piece 14, part of the plug 3, and part of the plate body 11 to expose the hook plate 13 and the part of the plate body 11 having the locking hole 110. Finally, the top cover 22 is snapped to the bottom cover 21. In this way, the flexible clip 10 and the positioning cover 20 are combined with the plug 3.

It is worth noting that the disposition of the supporting piece 14 can provide greater elastic force for the hook plate 13. After the top cover 22 covers the supporting piece 14, the hook plate 13 can latch the positioning portion 102 of the network connection box 100 flexibly.

It is noted that the latch 131 is required to be disposed corresponding to the positioning portion 102. For example, if the latch 131 is an opening 1311 or comprises a plurality of openings 1311, the positioning portion 102 would be disposed having a slot 1021 and a positioning tab 1022 or a plurality of positioning tabs 1022 in the slot 1021, accordingly. In the current embodiment, the slot 1021 is spacedly disposed on a side of the plug hole 101 and the positioning portion 102 is a U-shaped opening. Thus, the positioning tab 1022 is latched in the opening 1311 and the plug 3 can be plugged into the plug hole 101 firmly.

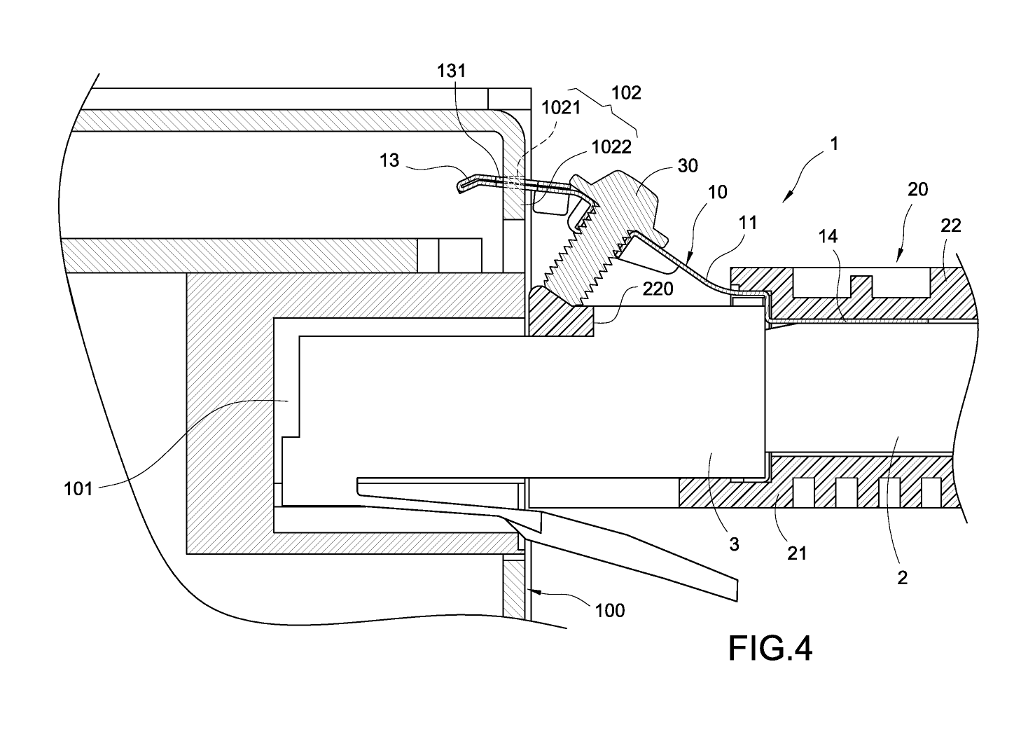

Please refer to FIG. 4, which is a cross-sectional assembled view of the structure of preventing the release of a network cable plug of the present invention. As shown in FIG. 4, after the plug 3 combined with the flexible clip 10 and the positioning cover 20 is plugged into the plug hole 101 of the network connection box 100, the positioning portion 102 of the network connection box 100 is latched in the latch 131 of the flexible clip 10. Moreover, when the fastener 30 passes through the locking hole 110, the fastener 30 will press against the plug 3 such that the fastener 30 cannot be released easily from the plug hole 101. As a result, the release of the plug 3 from the plug hole 101 can be prevented to make the plug 3 be plugged into the plug hole 101 firmly to ensure the electrical connection between the plug 3 and the network connection box 100.

The embodiments described above are only preferred ones of the present invention and not to limit the claimed scope of the present invention. Therefore, all the equivalent modifications and variations applying the specification and figures of the present invention should be embraced by the claimed scope of the present invention.

What is claimed is:

1. A structure of preventing the release of a network cable plug, which is combined with a plug of a network cable and connected to a plug hole with a positioning portion in a network connection box, the structure comprising:
a flexible clip comprising a plate body, a pair of pins extending from the plate body, and a hook plate connected to a side of the plate body, wherein the pair of pins is connected against a side of the plug and the hook plate has a latch, and
a positioning cover comprising a bottom cover and a top cover having a through groove, wherein the plug is arranged on the bottom cover, wherein the top cover covers part of the plug and part of the plate body through the plate body and the hook plate disposed through the through groove, wherein the plug is plugged into the plug hole, wherein the latch and the positioning portion are latched to each other.

2. The structure of preventing the release of the network cable plug according to claim 1, further comprising a fastener, wherein a locking hole is disposed on the plate body correspondingly, wherein the fastener passes through the locking hole and presses against the plug.

3. The structure of preventing the release of the network cable plug according to claim 2, wherein the fastener is an anti-theft screw and the locking hole is a screw hole.

4. The structure of preventing the release of the network cable plug according to claim 1, wherein flexible clip further comprises a supporting piece connected to the other side of the plate body, wherein the supporting piece is disposed between the pair of the pins and keeps a distance from the plate body, wherein the supporting piece and the part of the plate body are latched by the top cover.

5. The structure of preventing the release of the network cable plug according to claim 1, wherein the latch is an opening or comprises a plurality of openings.

6. The structure of preventing the release of the network cable plug according to claim 1, wherein the hook plate further comprises a reinforcement piece extending from the plate body, wherein the reinforcement piece is reversely stacked on the hook plate, wherein another latch identical to the latch is disposed on the reinforcement piece corresponds to a position where the latch is disposed.

7. The structure of preventing the release of the network cable plug according to claim 1, wherein the flexible clip is made of metal or plastic, wherein the plate body, the pair of pins, and the hook plate are integrally formed.

8. The structure of preventing the release of the network cable plug according to claim 1, wherein the positioning cover is made of metal or plastic, wherein the bottom cover and the top cover are integrally formed or separately disposed.

9. The structure of preventing the release of the network cable plug according to claim 1, wherein the positioning cover further comprises a flexible piece connected to the bottom cover and the top cover.

10. The structure of preventing the release of the network cable plug according to claim 1, wherein a plurality of hook grooves are spacedly disposed at the perimeter of the bottom cover and a plurality of hooks are spacedly disposed at the perimeter of the top cover, wherein the bottom cover and the top cover are combined by means of mutual latching of the hook grooves and the hooks.

11. A network connection box used in a structure of preventing the release of a network cable plug of claim 1, comprising a box body having at least one plug hole and a positioning portion disposed on a side of the at least one plug hole, wherein the plug is plugged into the plug hole, wherein the latch and the positioning portion are latched to each other.

12. The network connection box according to claim 11, wherein the positioning portion has a slot and a positioning tab in the slot, wherein the latch is an opening, wherein the positioning tab is latched in the opening.

13. The network connection box according to claim 12, wherein the slot is spacedly disposed on a side of the plug hole.

14. The network connection box according to claim 12, wherein the positioning portion is a U-shaped opening.
